(19) United States
(12) Patent Application Publication
(10) Pub. No.: US 2007/0191206 A1
(43) Pub. Date: Aug. 16, 2007

(54) Glass ceramic or glass body that can be subjected to great thermal loads and is decorated with a color based on a melted silicate containing effect pigments

(75) Inventors: Monica Cotlear De Witzmann, Nieder-Olm (DE); Dietmar Wennemann, Albig (DE); Angelina Milanovska, Mainz (DE); Ella Ruhl, Mainz (DE); Eva Lauterbach, Seibersbach (DE); Ioannis Kosmas, Stadecken-Elsheim (DE)

Correspondence Address: Striker Striker & Stenby, 103 East Neck Road, Huntington, NY, 11743, US

(73) Assignee: SCHOTT AG, Mainz (DE)

(21) Appl. No.: 10/593,982

(22) PCT Filed: May 3, 2005
(86) PCT No.: PCT/EP05/04775

§ 371 Date: Sep. 25, 2006

(30) Foreign Application Priority Data
May 6, 2004 (DE) 10 2004 022 257.6

(51) Int. Cl. C03C 3/076; B32B 17/06; B32B 18/00

(52) U.S. Cl. 501/55; 428/432; 428/210

(57) ABSTRACT

The invention relates to a glass ceramic or glass body that can be subjected to great thermal loads and is decorated with a color based on a melted silicate containing effect pigments. In order to reduce the protective look provided by the decoration, the melted silicate contains special effect pigments at a predefined ratio, said special effect pigments producing a color-flopping effect on the decorated glass ceramic of glass body. The human brain is hardly able to perceive the traces of wear as the tint changes according to the angle of vision. Preferably, the color-flopping color is based on a melted silicate to which effect pigments are added at a given ratio in the form of synthetic plane-parallel silicon dioxide (SiO₂) laminae which are coated with metal oxides.

The invention relates to a glass ceramic or glass body that can be subjected to high thermal loads and is decorated with a color based on melted silicate containing effect pigments.

Such colorants based on a silicate melt are typically ceramic colorants with molten glass as a base. Said colorants are baked onto the substrate at a very high temperature.

A mixture of this colorant base with effect pigments confers to the glass ceramic or glass body decorated with the said mixture not only a color but also additional properties (effects). Typical effect pigments are the luster pigments and particularly the metal effect pigments that produce a metal-like luster.

Glass ceramic or glass bodies decorated with the afore-said colorants containing luster pigments are made, in particular, as glass ceramic plates or plates consisting of tempered special glass with a low thermal expansion coefficient, such as borosilicate glass, used typically for cooking surfaces in cooking areas, namely where said plates are subjected to high thermal loads. However, for example fireplace sight glasses, baking oven sight glasses and lamp covers made of these materials which are also subjected to high thermal loads are increasingly also being decorated with the afore-said colorants.

Because, in particular, cooking surfaces in cooking areas of modern kitchens are conspicuous because of their large surface area and decisively influence the design which is markedly customer-dependent and differs from country to country, the most varied decorations are described in numerous publications. They range from simple patterns, for example company logos or cooking area markings, to complex full-surface decorations. Important besides the design is, in particular, the protection against surface scratches and the reduction in susceptibility to soiling, for example to finger prints and metal particles produced by abrasion as well as to marks resulting from use. Such decorations and their application to a glass ceramic plate are described, for example, in DE 44 26 234 C1 (=EP 0 693 464 B1) and DE 34 33 880 C2. Other decorated cooking surfaces are disclosed in DE 197 28 881 C1 (=DE 297 11 916 U1), DE 100 14 373 C2 and DE 200 19 210 U1. The last two publications also describe decorations with sol-gel-based colorants containing metal effect, pearlescent or interference pigments, namely effect pigments producing a metallic effect in the color. Such molten glass-based colorants, namely ceramic metallic colorants containing such pigments are also known from the prior art.

Such a pearlescent pigment based on coated luster platelets is commercially available under the tradename IRIODIN® (Merck).

In certain market segments, and especially for adaptation to aluminum and stainless steel surfaces in modern kitchens, such decorated glass/glass ceramic cooking surfaces with a metallic effect occupy an important position.

The ceramic colorants used in practice to date for the decoration of glass cooking surfaces and glass ceramic cooking surfaces, fireplace sight glasses and other flat-glass surfaces that are exposed to high thermal loads are systems containing one or more molten glasses mixed with a colored pigments or pigments and optionally fillers. After baking, the colorant affords a more or less homogeneous coating of a certain coloration. In the case of the pigments that became known under the tradename IRIODIN® and with other effect pigments this coloration is further intensified by varying light reflection on the coated luster platelets resulting in the known “metallic effects” of ceramic colorants.

The drawback of the aforesaid colorants is the more or less pronounced conspicuousness of use marks, scratches, metallic particles abraded from cooking pans etc on the cooking surfaces, because the intact colors of the decoration offer a homogeneous picture to the human eye. Any interruption of the homogeneity is therefore immediately registered and perceived as a fault.

Hence, the invention has for an object to decorate a glass ceramic or glass body that can be subjected to high thermal loads with such a colorant based on melted silicate that contains special-effect pigments capable of reducing the conspicuousnes of use marks, scratches, and abraded metallic particles compared to the known, decorated glass ceramic or glass bodies.

According to the invention, this objective is reached by way of a silicate melt that contains a specified amount of special-effect pigments which show a color-flop effect on the decorated glass ceramic or glass body.

By use of certain effect pigments, particularly of special interference or pearlescent pigments, it is possible to obtain colors showing a so-called color-flop effect, also referred to as changing or flip-flop effect. Colors with such pigments change the hue depending on the angle of view. The main color is highly pronounced only at a certain viewing angle. The colors seen from other viewing angles depend on a number of factors and particularly on the background color of the substrate.

By use of such colorants it is possible to reduce the conspicuousness of use marks, scratches etc. by adjusting the colorant to produce a refined color change that depends on the angle of view (color-flop) so that the human brain no longer perceives the use marks.

Hence, for the decoration of glass ceramic and special glasses, especially for use on cooking surfaces, fireplace sight glasses etc, a suitable molten glass is mixed with special, suitable color-flop pigments. This will produce a multicolor effect, for example from green to gray, from green to violet or from gold to dusky pink simply by changing the angle of view.

Although these effect pigments that bring about a color-flop effect are in themselves known, it was not obvious to use them in colorants based on a silicate melt, because they are not common in this industry and because their heat resistance as given by their manufacturers is not sufficient for use in such colorants with a silicate melt as base (stable up to 230° C. according to the manufacturer's Technical Data Sheet dated February 2003 and June 2002). According to product information supplied by the manufacturer Merck, said pigments are therefore always used in organic matrices, for example in automobile manufacture, in plastics, in printing inks and in lacquers. For this reason, it was not immediately obvious that these effect pigments could be used for decorating glass ceramic and glass bodies that are subjected to high thermal loads. Surprisingly, we have found that by adding the afore-said pigments to a silicate melt, particularly to molten glass, in a manner in which they are usually employed for decorating glass ceramics and special glasses, the heat resistance can be increased to such an extent that an entirely new field of application opens up for them.

According to one embodiment of the invention, the color-flop colorant consists of a silicate melt as base to which are added specified amounts of effect pigments in the form of synthetically produced plane-parallel silicon dioxide (SiO₂) platelets coated with metal oxides.

Such effect pigments show a pronounced color-flop effect.

To this end, appropriate effect pigments commercially supplied by the Merck company under the tradename Colorstream® are preferably used. The very thin, flat, optimally plane-parallel pigment particles produce unusually changing intereference effects, namely a multicolor effect. Even under subdued light, the color change of the pigments is quite pronounced. The special aesthetics in this case are due to the soft, flowing transition of the colors.

By varying the coatings on the plane-parallel SiO₂ Colorstream® pigment platelets, color-flop pigments of various hues can be prepared, for example:

1. Colorstream® Autumn Mystery
The color changes from red to impressive gold and bronze to green.

2. Coolorstream® Viola Fantasy
The color changes from a strong lilac to silver and green to blue.

3. Colorstream® Arctic Fire
The color changes from turquois to brilliant silver to metallic red and gold.

Preferably, the base of the ceramic colorant with the color-flop pigments of the invention is a molten glass.

The molten glass preferably has the following composition (in wt. %):

| | |
|---|---|
| Li₂O | 0-5 |
| Na₂O | 0-5 |
| K₂O | <2 |
| ΣLi₂O + Na₂O + K₂O | 1-10 |
| MgO | 0-3 |
| CaO | 0-4 |
| SrO | 0-4 |
| BaO | 0-4 |
| ZnO | 0-4 |
| B₂O₃ | 15-27 |
| Al₂O₃ | 10-20 |
| SiO₂ | 43-58 |
| TiO₂ | 0-3 |
| ZrO₂ | 0-4 |
| Sb₂O₃ | 0-2 |
| F | 0-3 |

This composition of the molten glass—in the following referred to as “GF1”—is the same as that indicated in DE 197 21 737 C1, the disclosures of which are taken into account in the present application by this reference. Depending on the application, other usable glass compositions are described in DE 19834 801 C2, FR 2 732 960, EP 1 119524 B1, DE 4201 286 A1 and EP 0 460863 B1.

Besides the special color-flop pigments added to the molten glass according to the invention, common fillers and/or other conventional colored pigments, for example colored bodies (spinels), can optionally also be added. The Colorstream® effect pigments in combination with other colored pigments are particularly effective in so-called stylings.

The decoration is preferably done by screen printing, particularly in the case of glass/glass ceramic cooking surfaces. In this case, unusual difficulties concerning the fabrication technique had to be overcome. The paste preparation/adjustment to the correct viscosity and the particle size of the pigments for screen printing use presented special problems. In this sense, the prior art offered no assistance, because the color-flop pigments to be used, dissolved in organic solvents, are typically applied by spraying, especially in the case of automotive lacquers.

The thickness of the decoration according to the invention is typically in the 1.0-6 μm range.

### PRACTICAL EXAMPLES

1. Molten “GF1” glass (as per DE 197 21 737 C) +20 % of the effect pigment Colorstream® T 10-02 Arctic Fire multicolor effect pigment, made into a paste with a conventional screen printing medium and then printed onto glasses/glass ceramics that became known as products having the following tradenames:
   a) CERAN HIGHTRANS® cooking surfaces
   b) CERAN SUPREMA® cooking surfaces

2c) ROBAX® fireplace sight glasses
d) CERAN ARCTIC FIRE® cooking surfaces
e) CERADUR® cooking surfaces
   always produces a color flop from green to violet with varying color intensities depending on the background color of the substrate
2. Molten “GF1” glass +20% of effect pigment Colorstream® F 10-00 Autumn Mystery multicolor effect pigment +3% of M 91884 black pigments (Heraeus), made into a paste with the screen printing medium and then printed onto the same substrates as in the first example.

This always gives a color flop from brass to dusky pink with different color intensities depending on the background color of the substrate.

In both practical examples, the color intensity is highest in substrate cases a) and b). In case c), the color-flop effect appeared with reduced color intensity and on a transparent dulling, and in cases d) and e) on the“silk-white” background color.

1. Glass ceramic or glass body that can be subjected to high thermal loads, decorated with a colorant based on a silicate melt containing effect pigments, characterized in that the silicate melt contains a specified amount of special-effect pigments which on the decorated glass ceramic or glass body show a color-flop effect.

2. Glass ceramic or glass body as defined in claim 1, characterized in that the special-effect pigments consist of synthetically produced, plane-parallel silicon dioxide (SiO₂) platelets coated with metal oxides.

3. Glass ceramic or glass body as defined in claim 2, characterized in that the special-effect pigments are effect pigments supplied commercially by the Merck company under the tradename Colorstream® multicolor effect pigments.

4. Glass ceramic or glass body as defined in claim 3, characterized in that the effect pigment is one bearing the tradename Colorstream® Autumn Mystery.

5. Glass ceramic or glass body as defined in claim 3, characterized in that the effect pigment is one bearing the tradename Colorstream® Viola Fantasy.

6. Glass ceramic or glass body as defined in claim 3, characterized in that the effect pigment is one bearing the tradename Colorstream® Arctic Fire.

7. Glass ceramic or glass body as defined in claim 1, characterized in that the silicate melt consists of molten glass.

8. Glass ceramic or glass body as defined in claim 7, characterized in that the molten glass has the composition (in weight %):

| | |
|---|---|
| Li₂O | 0-5 |
| Na₂O | 0-5 |
| K₂O | <2 |
| ΣLi₂O + Na₂O + K₂O | 1-10 |
| MgO | 0-3 |
| CaO | 0-4 |
| SrO | 0-4 |
| BaO | 0-4 |
| ZnO | 0-4 |
| B₂O₃ | 15-27 |
| Al₂O₃ | 10-20 |
| SiO₂ | 43-58 |
| TiO₂ | 0-3 |
| ZrO₂ | 0-4 |
| Sb₂O₃ | 0-2 |
| F | 0-3 |

9. Glass ceramic or glass body as defined in claim 1, characterized in that to the silicate melt are added besides the special-effect pigments also common fillers and/or other conventional colored pigments.

10. Glass ceramic or glass body as defined in claim 1, characterized in that the decoration is done by screen printing.

11. Glass ceramic or glass body as defined in claim 1, characterized in that the special-effect pigments amount to 1 to 30 wt. % of the pigments.

12. Glass ceramic or glass body as defined in claim 1 constituting the cooking surface of a cooking area with the decoration on the topside of the cooking surface.
